(19) United States
(12) Patent Application Publication
(10) Pub. No.: US 2004/0257728 A1
(43) Pub. Date: Dec. 23, 2004

(54) Electrostatic discharge protection device and network with high voltage tolerance

(76) Inventor: David Yu Hu, Singapore (SG)

Correspondence Address: STEPHEN B. ACKERMAN, 28 DAVIS AVENUE, POUGHKEEPSIE, NY, 12603, US

(21) Appl. No.: 10/872,912

(22) Filed: Jun. 21, 2004

Related U.S. Application Data
(60) Provisional application No. 60/320,296, filed on Jun. 20, 2003.

(51) Int. Cl. H02H 9/00

(52) U.S. Cl. 361/56

(57) ABSTRACT

This invention relates to a protection network for electrostatic discharge in between the VDD power line and IO pad or two different power line of two different potentials. In more particular a series devices in combination with at least one NMOS which substrate is completely isolated from its N-diffusion to form a protection network between the IO pad and Vdd line so that the IO pad can sustain high voltage than the VDD power. Different embodiments are shown. The application of such device or devices is independent of voltage difference and the power on or off sequence. Further more those devices can be used when hot-plug is required which means inserting such device during the power on would not introduce any significant transient leakage current between the IO pad and Vdd.

### BACKGROUND OF THE INVENTION

(1) Field of the Invention

The present invention relates in general to a semiconductor device and circuit for electrostatic discharge (ESD) protection. In more particular, to the protection clamp therefore made by such devices between the power line and the I/O pad whereby the IO pad node is able to sustain higher voltage than the power line during the normal operation.

(2) Description of the Prior Art

Electrostatic discharge is an event where sudden charges transfer between one body to another. The rapid charge transfer generates voltages large enough to breakdown insulating films, such as gate oxide, and to cause permanent damage to the MOS device. Normal way of ESD protection is to build integrated circuits of various structures on the input and output pins to shunt ESD currents away from sensitive internal structures.

FIG. 1 (Prior Art) shows a typical ESD protection network. In this circuit, an internal circuit voltage, SIGNAL 20, is propagated to an output pin, PAD 24. A driver stage inverter is made up of NMOS transistor N18 and PMOS transistor P18. The output of the driver stage is tied directly to the output PAD 24. In addition, two protection devices, N2 and P2, are used in a dummy stage such that each device is OFF during normal operating conditions. However, if a negative voltage spike occurs at PAD 24, then the dummy stage protection devices turn ON and shunt current to either ground 10 (Vss)or to the supply voltage (Vdd) 30. In addition, if a large positive voltage spike occurs at PAD 24, then the diodes formed by the drain to substrate junctions of N2 and P2 will forward bias and provide a current shunt. However, such PMOS with its bulk tied to the Vdd at 3.3 volt, the pad cannot tolerate higher than the Vdd 3.3 volt for example 5 volt due to forward biasing of the PN junction that introduce leakage path between the pad node to the Vdd power bus. The way to overcome this forwarded PN junction is to introduce the floating N-well technique. The self-biasing N-well can be used for both ESD protection and the output driver. When the pad node is higher than Vdd, the floating Nwell is able to sustain the higher voltage without forward biasing the PN diode, but for the normal operation, the self biasing PMOS will let the bulk short to the Vdd. (See “ESD Proetction in a Mixed Voltage Interface and Multirail Disconnected Power Grid Environment in 0.50- and 0.25-um Channel Length CMOS Technologies”, by Steven H. Voldman, IEEE Transactions on Components, Packaging, and Manufacturing Technology—Pt. A Vol. 18(2), p.303-313, June 1995).

U.S. Pat. No. 5,969,541 to Waggoner et al gives an example of how floating Nwell can be biased in a controllable manner.

U.S. Pat. No. 6,353,520 to Andersen et al. suggests the use of a serial diode chain between the Vdd to the pad and a cascaded NMOS from the pad to Vss in order to tolerate voltage which is higher than the supply voltage and close to the gate oxide break down limit.

U.S. Pat. No. 6,181,214 to Schmitt et al showed the cascaded NMOS as input cell for ESD protection between the IO pin to the ground with high voltage tolerance.

U.S. Pat. No. 6,444,511 to Wu et al. has demonstrated a fabrication method and device for an enhanced ESD protection between IO pin to VSS using cascaded NMOS.

### SUMMARY OF THE INVENTION

A primary object of the invention is to provide a protection device and network that can sustain higher voltage than the supply at the pad node during the normal operation while during the electrostatic discharge occurs it can snap back and have a lower holding voltage so that a low resistance path can be formed and the discharge current can be transferred from the pad node to the ground or Vdd power bus without damaging to its internal sensitive circuit.

Another object of the invention is to provide a protection device or network that is independent from the power turn on and turn off sequences. Therefore in both circumstances no transient or instantaneous current leakage shall be introduced.

A third object of this invention is to provide the protection device in between the Vdd to the IO pad node that it can be plugged in while the power is still on without transient or instantaneous current leakage from the power (hot pluggable).

A fourth object of this invention is to provide the protection device that can have a very high impedance in between the Vdd and the pad node during the normal working condition and can be triggered into a low resistance path at the event of ESD by turning on the parasitic NPN bipolar transistor.

A further object of this invention is to provide the protection device or network in between any two different power nodes that can sustain whichever side is higher voltage than the other node during the normal working condition.

Yet a still further object of this invention is to provide the protection device or network in between the Vdd and the IO pin so that a parasitic NPN structure is formed and during the ESD stress, the P substrate is floating, and the NPN can be triggered to turn on at much lower voltage than the scheme that both P substrate and N diffusion source are tied together to the ground.

In accordance with the objects of the invention, one method is to have at least one nmos with its diffusion as source node connected to the Vdd and the drain connected to the pad node and its gate and substrate are tied to the ground. The formation of such NMOS (hereafter will be named as Vdd_NMOS) is no different from the NMOS between the Pad node to Vss (Vss_NMOS) except that its NMOS source is isolated from the P-substrate.

Also, in accordance with the objects of the invention, a second method is to have its Vdd_NMOS gate tied together with its Vss_NMOS gate for example to tie to the ground through a resistor.

Also, in accordance with the objects of the invention, a third method for forming a Vdd_NMOS is achieved. First and third active areas of a cascaded NMOS semiconductor device are separated and shared by a common P+ implant area in the middle of the two active areas. The first active area of such a cascaded NMOS is in connection to its Vdd node and the third area of such a cascaded NMOS is in connection with the pad node. The second, or the area with P+ implant in the middle is kept floating and it should be connected through the substrate resistance to the ground or Vss node.

In a very similar fashion as the above method, also in accordance with the objects of the inventions, a fourth method of forming such Vdd_NMOS is to have Nwell underneath the first active area with P+ implant area in addition to the N+ active area. This will form a PNPN SCR structure which will snapback at event of ESD and provide efficient discharge path.

Also, in accordance with the objects of the invention, another method of forming a better Vdd_NMOS is achieved. By having two dummy NMOS with its drain sharing the same source diffusion of the VDD_NMOS connecting to the Vdd power line, and its source to the ground, and its gate tied down to the substrate or through a resistor, this method can achieve a better and smooth current distribution during the ESD event.

Also, in accordance with the objects of the invention, another method of forming a cascaded VDD_NMOS is achieved. The first active device of the cascaded NMOS is replaced by a PMOS and the second active NMOS with its gate tied down to the Vss or ground. In this way, a similar PNPN SCR snapback structure is realised.

This invention uniquely provides a series of novel semiconductor devices and methodologies of using these devices to form part of the ESD protection network. Having the NMOS in between the Vdd and Io pin, or in between different power lines, its substrate becomes floating during the ESD stress, this will result in early turn on and low trigger voltage, which is ideal for the deep submicron CMOS technology.

### BRIEF DESCRPTION OF THE DRAWINGS

In the accompanying drawings from a material part of this description, there is shown:

FIG. 1 is a common ESD protection network found in prior art. In between the Pad to Vdd there is a gate tied PMOS and in between the Pad to the Vss there is a grounded gate NMOS.

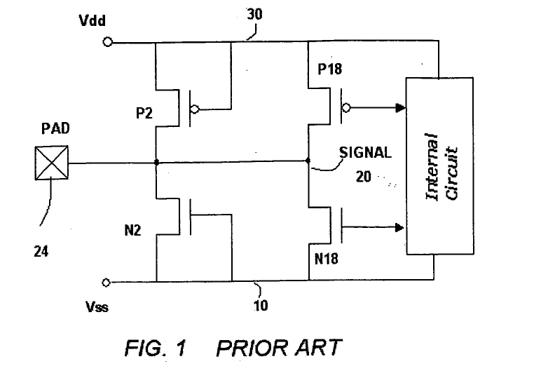

FIG. 2 depicts the protection device and network of the prior art (see U.S. Pat. No. 6,353,520 to Andersen et al.). A Darlington diode chain forms the pad node to Vdd protection path and a pair of cascaded NMOS is used to form the protection path between pad to Vss.

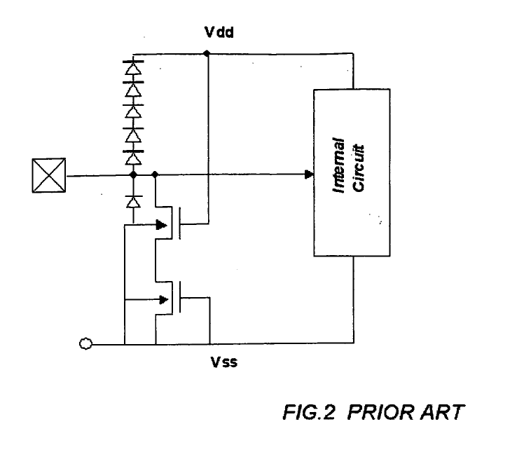

FIG. 3 shows the self-biasing N-well used for both ESD protection and the output driver. This prior art teaches when pad node is higher than Vdd, the floating N-well is able to sustain the voltage without forward bias the pn diode, and for the normal operation the self-biasing PMOS will let the PMOS bulk short to the power Vdd.

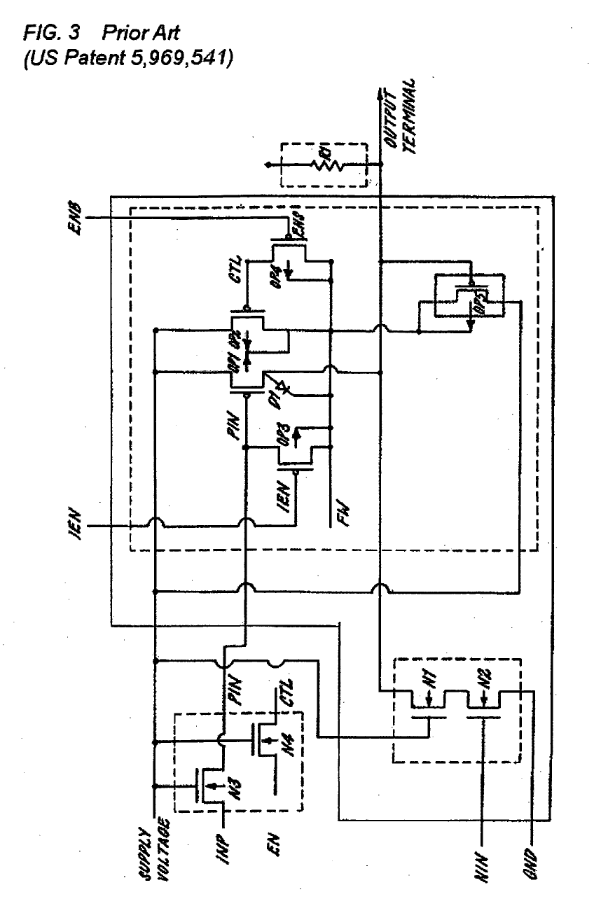

FIG. 4 is the schematic drawing of the first preferred embodiment of this invention. In it, a cascaded NMOS is placed in between the Vdd to the IO pins to form the part of protection network.

FIG. 5 is the cross-sectional view of the first preferred embodiment of this invention. In that all the parasitic diodes are shown in dotted lines. The cascaded NMOS between VDD and IO pad together with the cascaded NMOS between IO pad to Vss forms a unique ESD protection network.

FIG. 6 is the schematic drawing of the second preferred embodiment of the present invention. With a small variation to the first embodiment by gate coupling circuit, this protection scheme can provide a more effective application for the ESD.

FIG. 7 shows the third preferred embodiment of the invention. A cascaded NMOS having the base area with additional P+/P− implant can have a lower breakdown voltage between the Vdd drain to source (IO pad node), than just an ordinary cascaded NMOS.

FIG. 8 is the fourth preferred embodiment of the invention. Two similar RC triggering network one for the gates tied to the Vdd and one for the gates tied to the Vss can be implemented for better turn on and triggering at the event of ESD.

FIG. 9A shows the more simplified approach. In this preferred embodiment having a NMOS transmission gate commonly shared by both VDD NMOS and VSS NMOS can reduce the IO area.

FIG. 9B gives an example by the same principle; a high voltage tolerant typically for analog and RF input is derived. Unlike the high voltage tolerant pad used for the digital input, this analog pad has no resistive path in between the pad to its internal circuit.

FIG. 9C shows with the same merit, how a parasitic PNPN structure similar to a Silicon Controlled Rectifier (SCR) is formed between the Vdd to IO pin by having an additional p+ implant at the drain side of the VDD_NMOS. This will add more efficient ESD breakdown path when stressed positively to Vdd with respect to IO pad.

FIG. 10A showed the cascaded NPMOS (PMOS and NMOS in cascade) as another embodiment to achieve the similar protection goal.

FIG. 10B is the slight variation from the 10A. In this embodiment, the lower NMOS has its N-Diffusion merged with the N-well to reduce the breakdown length between the Pad node to Vdd.

FIG. 10C is the extension to the scheme in 10B. In this scheme the breakdown path from Vdd to IO pin can be made as the PNPN SCR structures.

FIG. 11 is the cross-sectional view of the layout it that it shows how the pad node and Vdd are connected with two dummy NMOS next to the node which are tied to the Vdd node. This consequently add additional path from Vdd to Vss protection or the whole chip ESD protection.

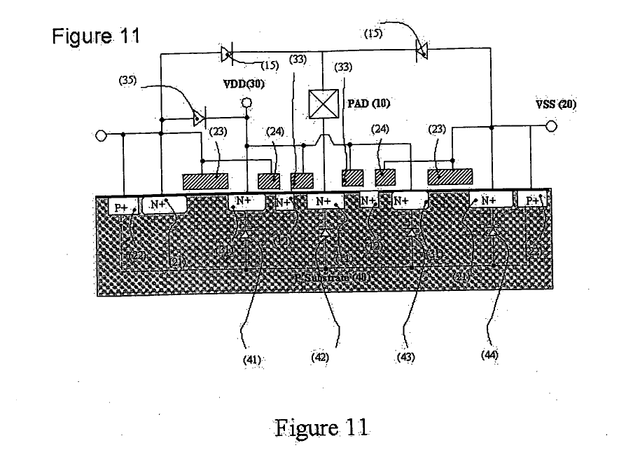

### DESCRPTION OF PREFERRED EMBODIMENT

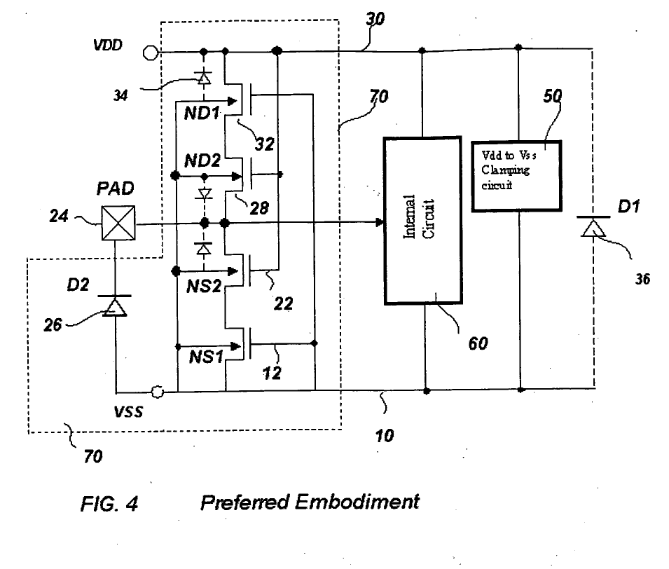

Refer now to the FIG. 4. In between the PAD 24 and VDD 30 there are two cascaded VDD_NMOS. The first VDD_NMOS (ND1) 32 which source diffusion is connected to VDD 30 and its drain shares the same diffusion with the second VDD_NMOS (ND2) 28. The drain of the second VDD_NMOS 28 is connected directly to the PAD 24.

Of the similar fashion, two cascaded VSS_NMOS are found in between the PAD 24 and the ground VSS 10. The gate of first VDD_NMOS 32 and the first VSS_NMOS 12 are tied together and connected to the VSS 10 to ensure the path between the PAD 24 to VDD 30 and VSS 10 are turned off during the normal operation. The gate of the second VDD_NMOS 28 and the gate of the second VSS_NMOS 22 are tied together and connected directly to the VDD 30. The junction diode 26 between the PAD and VSS is inserted to form the protection network 70 at the PAD node.

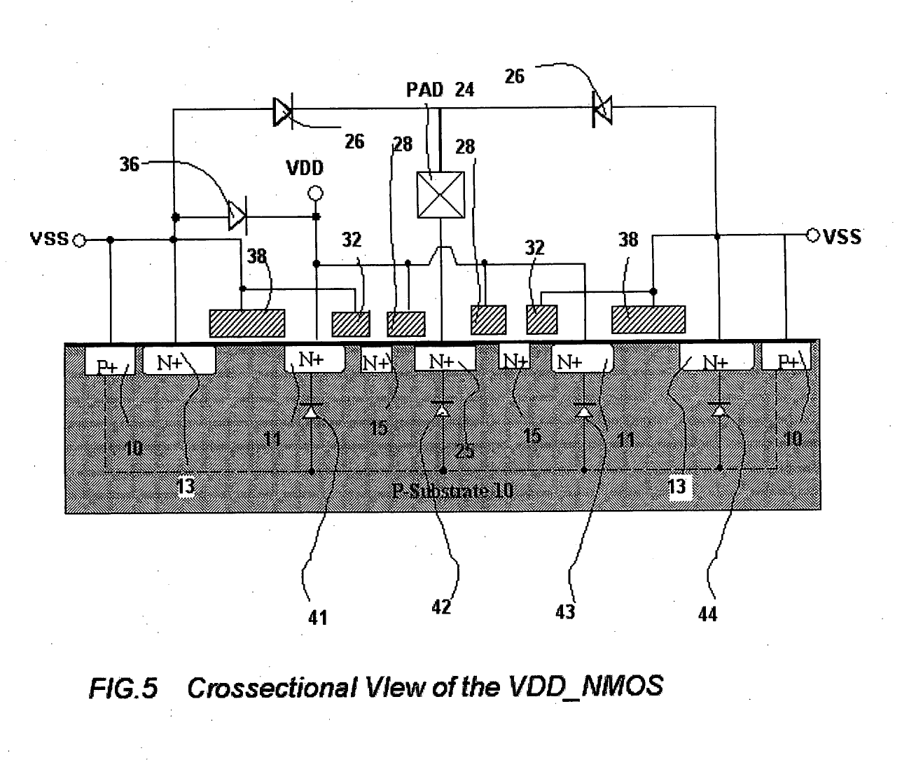

Now further refer to the FIG. 5, the cross-sectional view of the Cascaded VDD_NMOS of the first preferred embodiment. During the event of ESD, the PAD 24 is positively stressed with respect to the VDD 30, the junction 25 was reversely biased. The positive charge carriers are to be injected from the PAD through the reversely biased diode 42 and tentatively the substrate potential is raised up. However in this incident the P-Substrate 10 and Vss are floating. As soon as breakdown voltage of the PN junction has reached, avalanche effect will forward bias the PN junction between substrate to the N diffusion 11 connected to the VDD and that will result in a snap back operation between the PAD and VDD. Due to the symmetry of the NMOS structure, the VDD zaps with respect to the PAD can also be turned into a snap back operation. The dummy NMOS 38 with gate tied to the Vss are placed there to assist the current flow uniformity and enhance the VDD to VSS protection. However, this effect does help to forward bias the PN junction although the first NP junction breakdown voltage is higher (estimated to be BV=BVj+Vsub) Since the breakdown path goes through an reversed bias PN plus a forwarded PN junction, which is reasonably to assume that Vsub at the event of ESD should not be more than 0.7 volt. The junction diode 26 is placed in between the PAD and VSS to form the closed discharge loop. The junction diode 36 in between the VDD and VSS is also placed to form the discharge loop in case the snapback does not occur, then all the discharge path can still go through a reversely biased and forwardly bias diode chain to leak to the P-substrate. All the N-diffusions form a parasitic junction diode to the substrate, so during the stress of VSS verses PAD or VDD, the junction diode 41, 42, 43, and 44 are forwardly biased and hence the discharge current can easily flowing through without damage to the internal circuit. The floating N-diffusion 15 should be kept as minimum as possible.

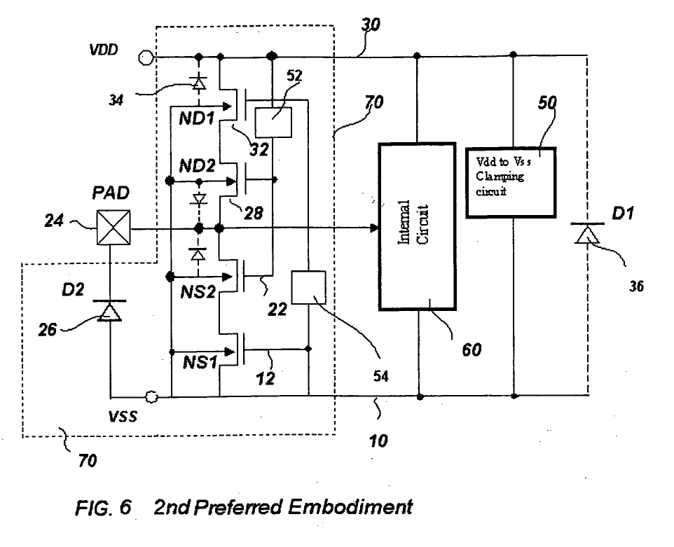

Refer now to the FIG. 6 which shows the second preferred embodiment. A VDD trigger circuit 52 is used to allow the gate of the 2^{nd} VDD_NMOS and VSS_NMOS to “softly” tie up to the VDD in order to reduce the gate stress and improve the gate triggering mechanism. For the same reason, the VSS trigger circuit or soft tie 54 is placed in between the 1^{st} VDD_NMOS and VSS_NMOS gate to the VSS 10. The trigger circuit or soft-tie defined in the boxes of 52 and 54 have one thing in common: during the normal operation it has a resistive path to the respective power node either be the VDD or VSS. For example, the trigger circuit can be composed of, but not just limited to, a singular usage, or a combination of resistors, MOS transistors and/or capacitors.

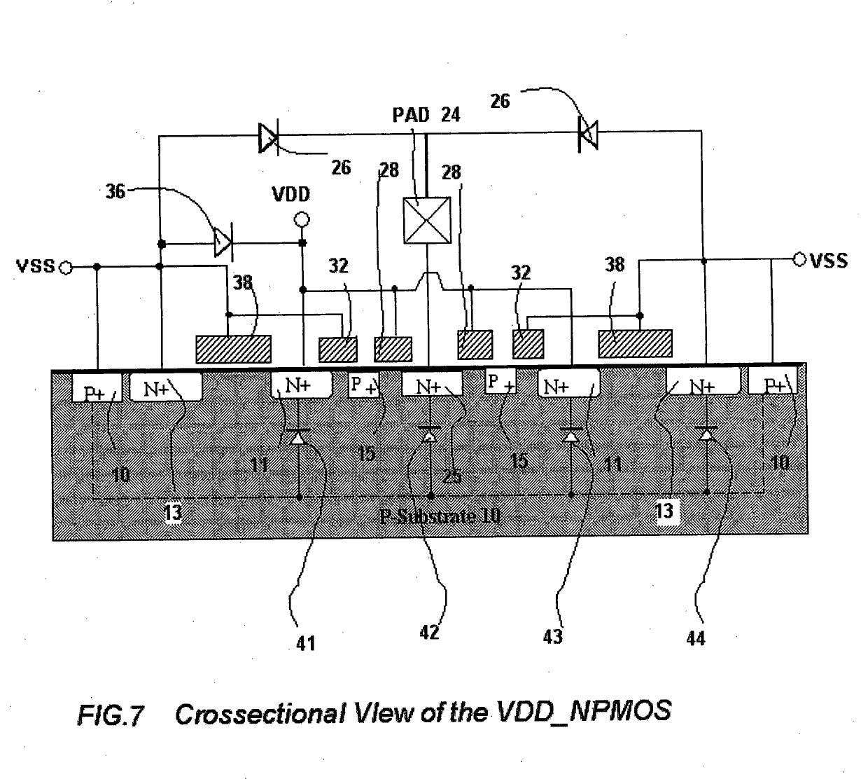

Refer further to the FIG. 7, which illustrates the usage of the NPMOS structure in place of the VDD_NMOS. The floating N-diffusion 15 in FIG. 5 has little contribution for the NPN snapback device, however, by using implant layer to convert the diffusion 15 from N+ into P+, thus a Cascaded NPMOS is formed. The P+ diffusion 15 in this embodiment is actually shorted to the P-substrate 10 and during the ESD event, the breakdown path becomes N+/P−/P+/P−/N+ which is much easier to go into snapback than the breakdown path of N+/P−/N+/P−/N+. The completed usage of this embodiment together with different gate triggering schemes forms the third preferred embodiment of this invention.

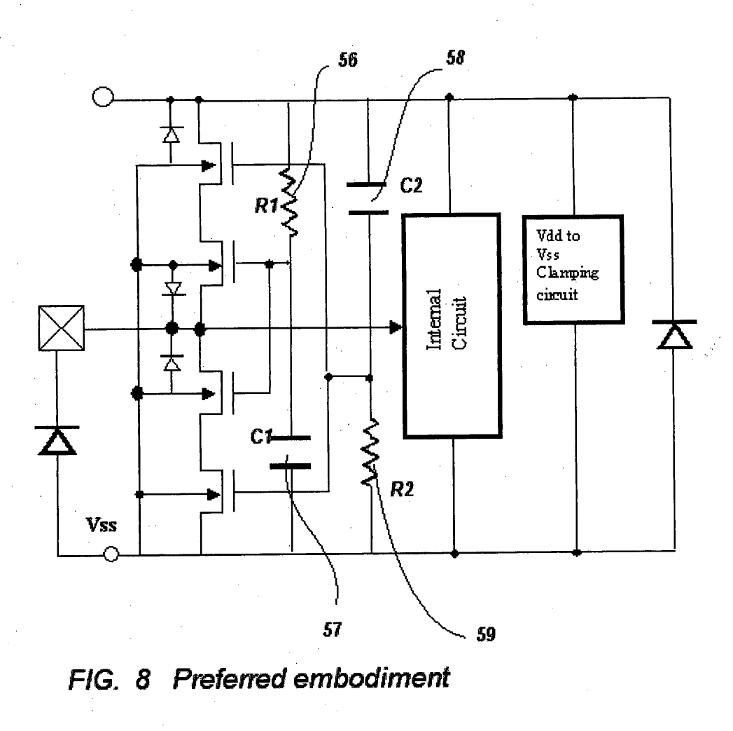

Refer to the FIG. 8 which shows the 4^{th} preferred embodiment using an RC trigger network for the cascaded VDD_ and VSS_NMOS gate triggering mechanism. In the figure the resistor 56 and 59 can be made but not limited to diffusions, Nwells, poly or metal and their value can either the same or different. The capacitor 57 and 58 can be made also not limited to, such as MOSCAP, MIM CAP or junction CAP. One set of RC network can be dedicated to both VDD_NMOS and VSS_NMOS, for example one of the gate connection is tied to the RC network through a regular inverter (Not drawn) in order to save some space.

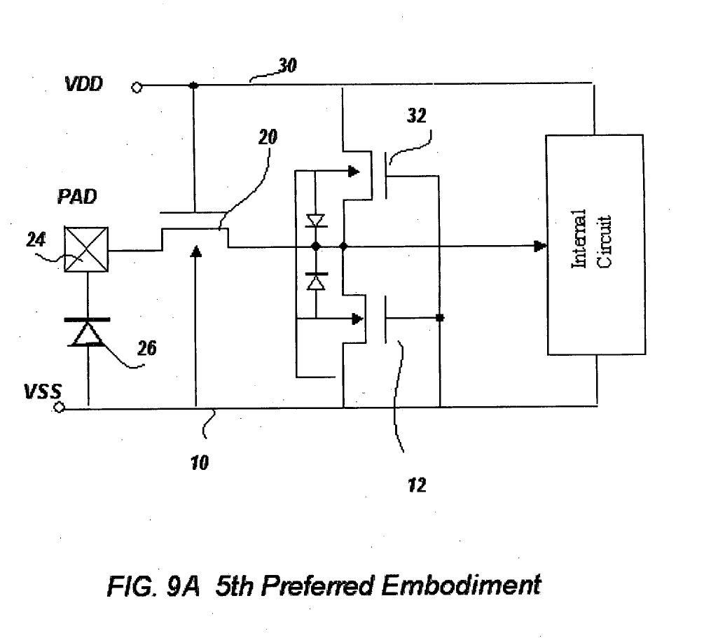

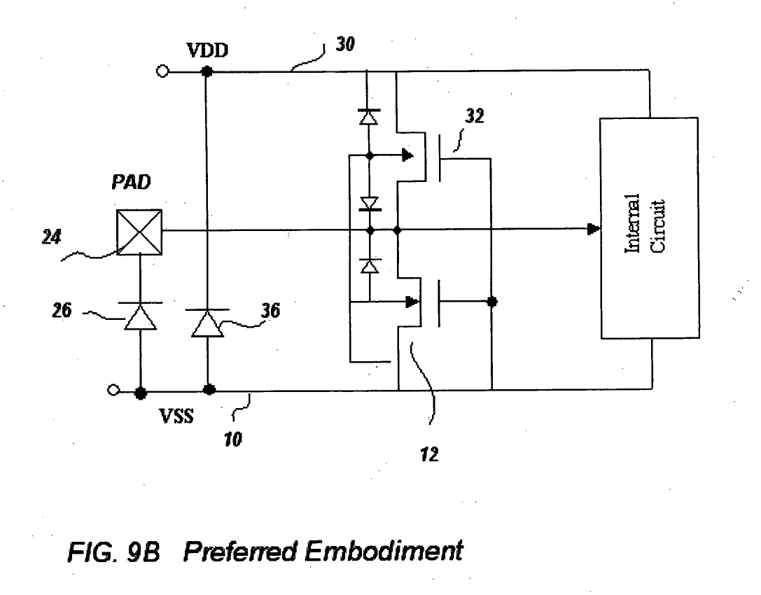

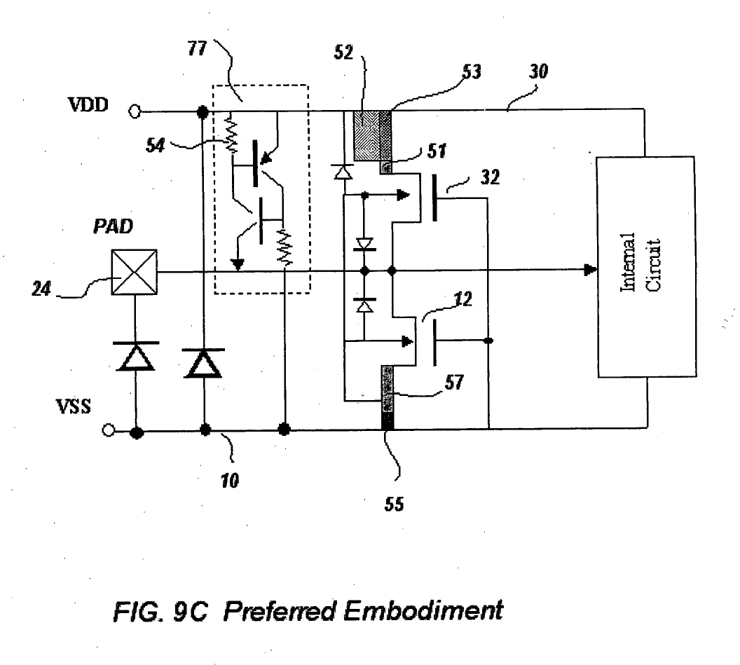

Refer to the FIG. 9A, which presents the 5^{th} preferred embodiment of this invention. The NMOS 20 was introduced with its gate tied up to the VDD 30 and drain diffusion in connection with the PAD 24. It acts like a resistor, or transmission gate which reduce the voltage swing and call allow the PAD to be tolerated above the voltage of VDD. NMOS 20 plays the role the same as the first VDD_NMOS 28 and VSS_NMOS 22 in the first preferred embodiment.

Refer now to the FIG. 9B. In this preferred embodiment, the PAD 24 is tolerable to a high voltage than VDD 30 as long as the voltage is not higher than the gate oxide breakdown limit. VSS_NMOS 12 and VDD_NMOS 32 are both turned off during the normal operation. When ESD zaps occur with respect to VSS 10, the grounding gate NMOS 12 snaps back to a bipolar transistor and forms the short resistance path to shunt the discharge current from the PAD 24 to the ground 10. Additional charges can also leak away through the reverse biased diode 26. When the pad 24 has an ESD stress with respect to the VDD 30, at this moment, the substrate 10 is floating and NMOS 32 turns into a parasitic bipolar transistor by voltage snap back and also forms the shortest resistance path to shunt the discharge current. In both manners the internal circuit is left safe without damaging to its circuit and the insulating films.

Now further refer to the FIG. 9C. In extension to the embodiment illustrated in FIG. 9B, a 7^{th} preferred embodiment is described. At the source side of NMOS 32 in connection with the VDD 30, by implanting P+ implant 53 and Nwell implant 52, a parasitic PNPN structure can be formed and its schematic is shown as inside the dotted box 77. The NMOS 32 still has its N-diffusion 51 connected to VDD 30 through the N-well parasitic Resistor 54. Similarly, the NMOS 12 has its source N-diffusion 57 short-connected to the P-diffusion 55 and connected to the grounding VSS 10.

Figures from 10A to 10B illustrate further how this invention can be implemented in a few different embodiments.

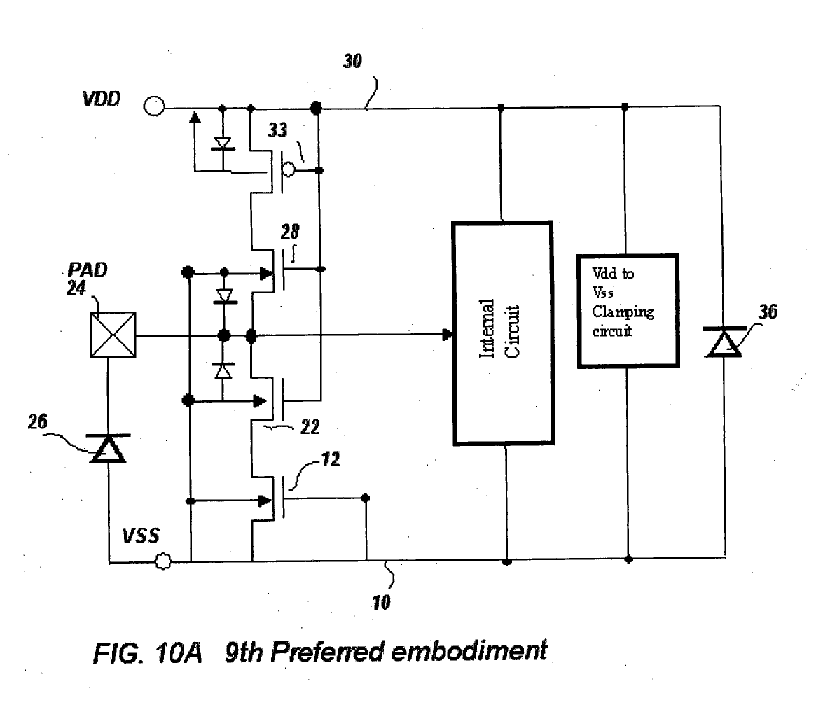

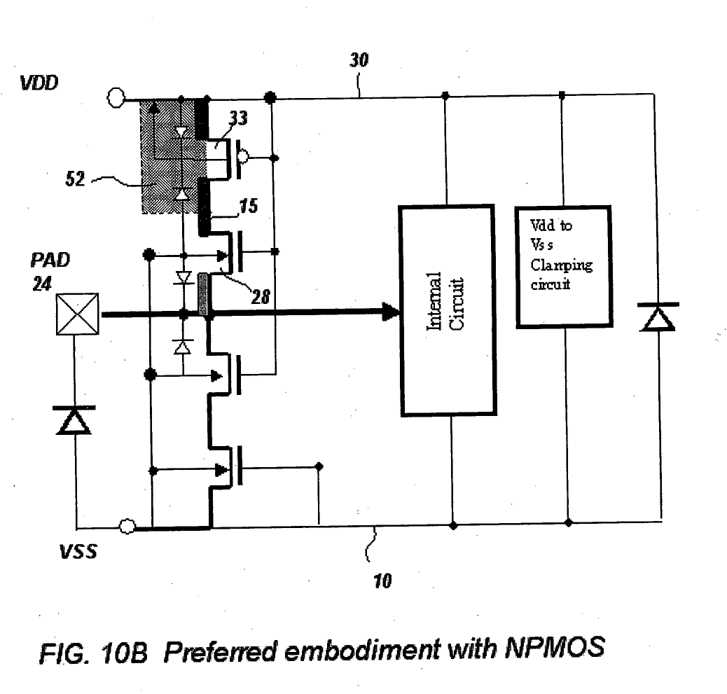

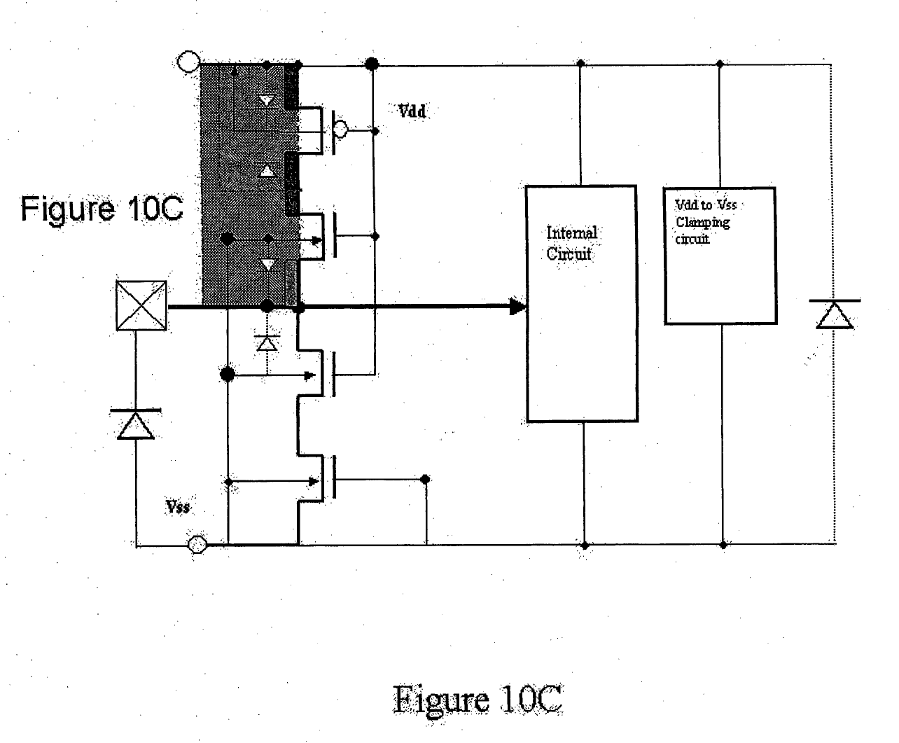

FIG. 10A shows that in place of the VDD_NMOS with its source tied to the VDD 30, a PMOS 33 can be used with its gate tied up to the VDD 30 and effective provides the same ESD protection with PAD 24 is still able to tolerate higher voltage than VDD.

FIG. 10B is the preferred embodiment with some alteration to the embodiment described in FIG. 10A. The Nwell 52 encloses the PMOS 33 and the P-diffusion 15 is implanted in between the PMOS 33 and NMOS 28 to form the NPMOS, which consists of upper PMOS 33 and lower NMOS 28. This structure gives different breakdown strength compared to just two NMOS cascaded together.

It will be understood by those skilled in the art that the invention should not be limited to the embodiment described herein, but can be extended and applied to any application in which it is desired to have voltage clamps between the two power supply lines or between the power line to the IO node.

What is claimed is:

1. An ESD protection network between the VDD power and the IO pad comprising at least one NMOS device of which at least one of its N-diffusion is connected to the IO pad node and its substrate is separated from either of its N-diffusions.

2. The device according to claim 1 its NMOS substrate is connected to the P-substrate at ground level.

3. The NMOS device according to claim 1 at least one of its NMOS gate is biased at the ground level during the normal operation condition.

4. The NMOS device according to claim 3 that its gate is connected to ground through a resistor.

5. The NMOS device according to claim 3 that its gate can be biased at zero potential through a biased circuit, for example an inverter or a RC triggering circuit.

6. A structure according to claim 1 comprising two NMOS devices in a cascaded mode in between the VDD power line and IO pad.

7. The said structure according to claim 6 that at least one of the NMOS its source is connected to the VDD power line.

8. The said structure according to claim 7 that its NMOS gate is connected to VDD power line through a resistance path.

9. The said structure according to claim 6 that two of its NMOS devices have their substrate isolated completely from any of their N-diffusions.

10. The said two cascaded NMOS devices according to claim 6 that at least one of it NMOS device share the same gate tie structure with the NMOS protection device in between the IO pad and VSS.

11. The said protection network according to claim 1 that at least one NMOS device having its gate biased at VDD with its drain in connection to the IO pad and its source connected to both N-diffusions of NMOS which source is connected to VDD and another NMOS which source is connected to VSS.

12. The said NMOS according to claim 11 which gate is biased at VDD through a resistive path during the normal operation.

13. What is further claimed is the said protection structure according to claim 1 that at least one of its NMOS device having its diffusion shared with another NMOS diffusion which source and substrate are tied together and its drain is connected to VDD.

14. The said structures according to claim 13 that its shared NMOS with its drain connected to VDD and source, gate and substrate connected together to VSS or ground potential.

15. Still what is further claimed is an ESD protection network in between the Vdd power and IO pad according to claim 1 that at least one of the cascaded NMOS is altered by implantation process step.

16. The said protection structure comprising at least one P+ diffusion inside the Nwell so that a PNPN breakdown path can be formed during the ESD stress.

17. The said protection structure according to claim 15 where by there are P+ diffusion in between the two cascaded NMOS so that a N+/P−/P+/P−/N+ breakdown path is formed.

18. the said protection device according to claim 17 that the P+ in between the two NMOS devices is shorted to the substrate having ground potential.

19 what is again further claimed according to claim 1 is the protection structure which contains PMOS in the cascaded mos structure.

20. The said protection structure according to claim 19 in which the Nwell has negative enclosure to the said PMOS so that a P+/N−/P+/P−/N+ breakdown path is formed in between the VDD to IO pad.
